(19) United States
(12) Patent Application Publication
(10) Pub. No.: US 2017/0102572 A1
(43) Pub. Date: Apr. 13, 2017

(54) METHOD FOR LIQUID CRYSTAL ALIGNMENT

(71) Applicant: Shenzhen China Star Optoelectronics Technology Co., Ltd., Shenzhen, Guangdong (CN)

(72) Inventor: Weiji Zhang, Shenzhen, Guangdong (CN)

(73) Assignee: Shenzhen China Star Optoelectronics Technology Co., Ltd., Shenzhen, Guangdong (CN)

(21) Appl. No.: 14/778,201

(22) PCT Filed: Jun. 18, 2015
(86) PCT No.: PCT/CN2015/081791

§ 371 Date: Dec. 1, 2016

(30) Foreign Application Priority Data
Jun. 4, 2015 (CN) 201510304516.X

(51) Int. Cl. G02F 1/1337; G02F 1/1341

(52) U.S. Cl. CPC G02F 1/13378; G02F 1/133723; G02F 1/1341

(57) ABSTRACT

A method for liquid crystal alignment is provided, comprising step 1: coating liquid state alignment film material containing paramagnetic chain-like particles on a display region of a substrate; step 2: placing the substrate in a constant magnetic field, so that the paramagnetic chain-like particles are stably arranged in a direction of the magnetic field; step 3: removing the magnetic field; and step 4: adding liquid crystal material into the display region of the substrate, so that molecules of the liquid crystal material align in the orientation of the paramagnetic chain-like particles. According to the method of the present disclosure, the use of rubbing cloth can be avoided, and non-contact liquid crystal alignment can be realized.

### CROSS REFERENCE TO RELATED APPLICATION

The present application claims benefit of Chinese patent application CN 201510304516.X, entitled “A Method for Liquid Crystal Alignment” and filed on Jun. 4, 2015, the entirety of which is incorporated herein by reference.

### TECHNICAL FIELD

The present disclosure relates to the technical field of display, and in particular to a method for liquid crystal alignment.

### TECHNICAL BACKGROUND

In the process of manufacturing a liquid crystal display device, an alignment procedure is required, so that liquid crystal molecules can align in certain orientations.

In the prior art, usually, a rubbing cloth is rubbed against a glass substrate. Upon rubbing, grooves with certain orientations are formed on the glass substrate. The liquid crystal molecules would align in accord with the grooves and form predetermined tilt angles, thereby completing the alignment procedure.

However, the friction of the rubbing cloth against the glass substrate would inevitably cause damage to the glass substrate as well as static electricity, thereby significantly influencing the stability of yield of the alignment procedure. As a result, the yield of the liquid crystal display device is also low.

### SUMMARY OF THE INVENTION

Directing at the above problem, the present disclosure provides a method for liquid crystal alignment. According to the method of the present disclosure, the use of rubbing cloth can be avoided, and the liquid crystal alignment can be realized in a non-contact manner.

The method for liquid crystal alignment according to the present disclosure comprises: step 1, coating liquid state alignment film material containing paramagnetic chain-like particles on a display region of a substrate; step 2, placing the substrate in a constant magnetic field, so that the paramagnetic chain-like particles are stably aligned in a direction of the magnetic field; step 3, removing the magnetic field; and step 4, adding liquid crystal material into the display region of the substrate, so that molecules of the liquid crystal material align in an orientation of the paramagnetic chain-like particles.

According to the method of the present disclosure, after arranging large amount of paramagnetic chain-like particles on the stable substrate in a predetermined direction through a magnetic field, molecules of the liquid crystal material are guided by the chain-like particles to align in the predetermined direction, thereby completing the liquid crystal alignment. In this case, non-contact liquid crystal alignment can be realized, whereby damage to the glass substrate will be avoided, and no static electricity will be generated. Thus, yield of liquid crystal display device manufactured based on the above can also be significantly increased.

In an embodiment according to the present disclosure, in step 2, the liquid state alignment film material is further precured. Herein, precuring refers to converting liquid state alignment film material to non-liquid state material, so as to avoid waste. In a preferred embodiment according to the present disclosure, in step 2, the substrate is pre-baked, so that the liquid state alignment film material is precured.

In an embodiment according to the present disclosure, in step 2, the constant magnetic field is a uniform magnetic field. In the uniform magnetic field, a direction and a magnetic strength in each position are respectively the same, whereby all the paramagnetic chain-like particles can align in the same direction.

In an embodiment according to the present disclosure, the paramagnetic chain-like particles are copper complex containing [Cu(NH₃)₄]²⁺ or [Cu(H₂O)₄]²⁺. The liquid state alignment film material further comprises polyimide and N-methylpyrrolidone as carrier liquid for the paramagnetic chain-like particles. In a preferred embodiment, a temperature of a pre-baking procedure is in a range from 80 to 100° C., and a magnetic strength of the uniform magnetic field is in a range from 0.1 to 1.5 T. Under the above conditions, the paramagnetic chain-like particles will turn rapidly and align stably in the direction of the uniform magnetic field. After the liquid state alignment film material is cured, the readily aligned paramagnetic chain-like particles will not change any more, thereby facilitating implementation of subsequent steps.

If the temperature is higher than 100° C., the liquid state alignment film material would be cured already before the paramagnetic chain-like particles are completely and stably aligned. As a result, the liquid crystal molecules would not be aligned in the orientation of the paramagnetic chain-like particles in a subsequent step. More importantly, an excessive temperature may cause the loss of paramagnetism of the paramagnetic chain-like particles, whereby the alignment of the paramagnetic chain-like particles cannot be guided by the uniform magnetic field at all. On the other hand, if the temperature is lower than 80° C., a curing velocity of the liquid state alignment film material would be very low, rendering production efficiency to be low. In addition, although higher magnetic strength can render rapid alignment of the paramagnetic chain-like particles, it would also cause waste of resources. On the other hand, if the magnetic strength is decreased, it is impossible for the paramagnetic chain-like particles to overcome rotational resistance, whereby the paramagnetic chain-like particles cannot be completely aligned in the direction of the magnetic field.

In a preferred embodiment according to the present disclosure, a mass content of the paramagnetic chain-like particles in the carrier liquid is in a range from 0.2 to 1%. Under the magnetic field, the paramagnetic chain-like particles in the liquid state alignment film material can rotate smoothly, rather than having difficulty to rotate or rotating insufficiently due to their entanglement with each other caused by excessive amount thereof.

In an embodiment according to the present disclosure, an additional step of removing paramagnetism of the paramagnetic chain-like particles is further performed between step 3 and step 4. After the paramagnetism of the paramagnetic chain-like particles is removed, the negative influence of the magnetic field on the paramagnetic chain-like particles in subsequent processes can be avoided, whereby influence on the alignment of molecules of the liquid crystal can be avoided. As a result, good performance of the liquid crystal device manufactured can be guaranteed.

In an embodiment according to the present disclosure, in the additional step, intensified baking is performed on the substrate at a higher temperature than the pre-baking. Preferably, the temperature of the intensified baking is in a range from 230 to 250° C. The paramagnetic chain-like particles no longer have paramagnetism through the intensified baking, whereby they are no longer susceptible to influence from outer magnetic field. Furthermore, in the intensified baking process, N-methylpyrrolidone in the liquid state alignment film material would volatilize, and polyimide would polymerize and form an alignment film firmly attached to the substrate. In this case, the production steps of the liquid crystal display device can be simplified.

As compared with the prior art, the present disclosure has the following advantages. According to the method of the present disclosure, large amount of paramagnetic chain-like particles are aligned on the stable substrate in predetermined direction under the magnetic field, and the paramagnetic chain-like particles guide the molecules of the liquid crystal material to align on the substrate in the predetermined direction, thereby realizing non-contact liquid crystal alignment. As a result, no damage would be caused to the glass substrate, nor would static electricity be generated, and the yield of the liquid crystal display device manufactured according to the present disclosure can be significantly increased. In addition, the method according to the present disclosure is simple and convenient to implement and the production cost is low.

### BRIEF DESCRIPTION OF THE ACCOMPANYING DRAWINGS

The present disclosure will be described in detail based on the examples in view of the accompanying drawings. In the drawings:

FIGS. 1-4 schematically show steps of a method according to the present disclosure.

In the drawings, same components are indicated with the same reference sign. The drawings are not drawn to actual scale.

### DETAILED DESCRIPTION OF THE EMBODIMENTS

The present disclosure will be described in detail in view of the accompanying drawings.

The method according to the present disclosure can be implemented by preparing liquid state alignment film material first. In an example, the liquid state alignment film material comprises N-methylpyrrolidone, polyimide and paramagnetic chain-like particles, in which N-methylpyrrolidone and polyimide are used as carrier liquid for the paramagnetic chain-like particles. Liquid state alignment film material comprising N-methylpyrrolidone and polyimide is well known to one skilled in the art, and thus will not be described in detail. The paramagnetic chain-like particles can be copper complex containing [Cu(NH₃)₄]²⁺ or [Cu(H₂O)₄]²⁺, which are also well known to one skilled in the art and will not be described in detail. The paramagnetic chain-like particles can be used as alignment guiding bodies for the molecules of the liquid crystal material. Polyimide can be used to form an alignment film on the substrate, which will be described in detail hereinafter.

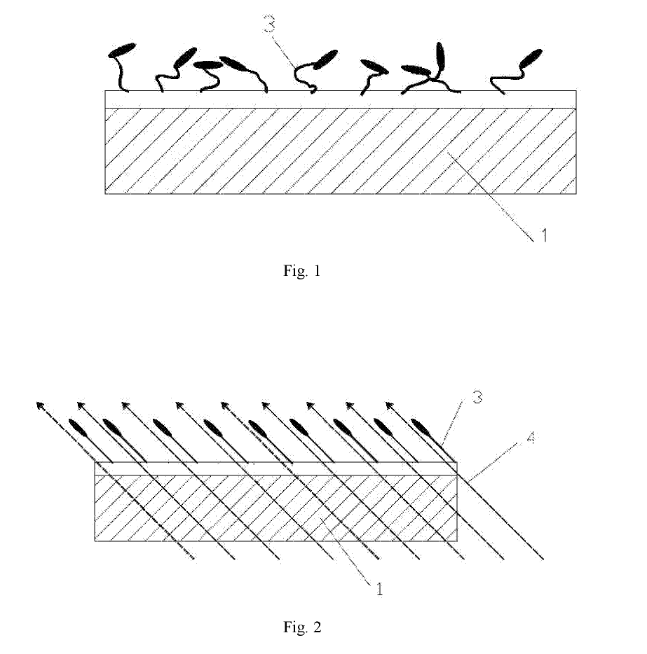

As shown in FIG. 1, liquid state alignment film material is coated on a display region of a substrate 1. Because there is no magnetic field to guide paramagnetic chain-like particles 3, orientations of the paramagnetic chain-like particles 3 on the substrate 1 are chaotic.

Subsequently, the substrate 1 is placed in a constant magnetic field 4. Under the action of the magnetic field 4, the paramagnetic chain-like particles 3 are aligned in a direction of the magnetic field 4. In a preferred example, the constant magnetic field 4 is a uniform magnetic field 4 as shown in FIG. 2. Each point within a scope of the uniform magnetic field 4 has a same magnetic strength. It should be understood that the magnetic strength is a vector. In this case, value and direction of the magnetic strength of each point within the scope of the uniform magnetic field 4 are respectively the same. In this case, the direction of the magnetic field 4 is a predetermined direction of liquid crystal alignment. Therefore, in an example, each of a plurality of paramagnetic chain-like particles 3 is stably aligned in the direction of the magnetic field 4, i.e., stably aligned in the predetermined direction of liquid crystal alignment.

In a specific example, a magnetic strength of the uniform magnetic field is in a range from 0.1 to 1.5 T. Under the above condition, the paramagnetic chain-like particles 3 can fully overcome rotational resistance and thus align in the direction of the uniform magnetic field 4. In a specific example, a mass content of the paramagnetic chain-like particles 3 in the carrier liquid thereof is in a range from 0.2 to 1%. In this case, the paramagnetic chain-like particles 3 would not entangle with each other in a large scale; instead, each particle can rotate relatively independently. If the content of paramagnetic chain-like particles is further increased, mutual resistance during rotation of the paramagnetic chain-like particles 3 would be significantly increased, which may even cause failure of alignment of the paramagnetic chain-like particles 3 in the direction of the uniform magnetic field.

In another example, while substrate 1 coated with liquid state alignment film material is placed in the constant magnetic field 4, the liquid state alignment film material is further precured. For example, the substrate 1 is pre-baked, so that the liquid state alignment film material can be precured. In a specific example, a temperature of a pre-baking procedure is in a range from 80 to 100° C. After the liquid state alignment film material is precured, the already aligned paramagnetic chain-like particles 3 would not change status any more, thereby facilitating subsequent steps. Because paramagnetic chain-like particles 3 can turn rapidly under the uniform magnetic field 4 and a velocity of the precuring is relatively slow, precuring the liquid state alignment film material would not influence the alignment of the paramagnetic chain-like particles 3. On the contrary, the aligned sate of the paramagnetic chain-like particles 3 can be stabilized.

After the liquid state alignment film material is cured, the magnetic field 4 is removed.

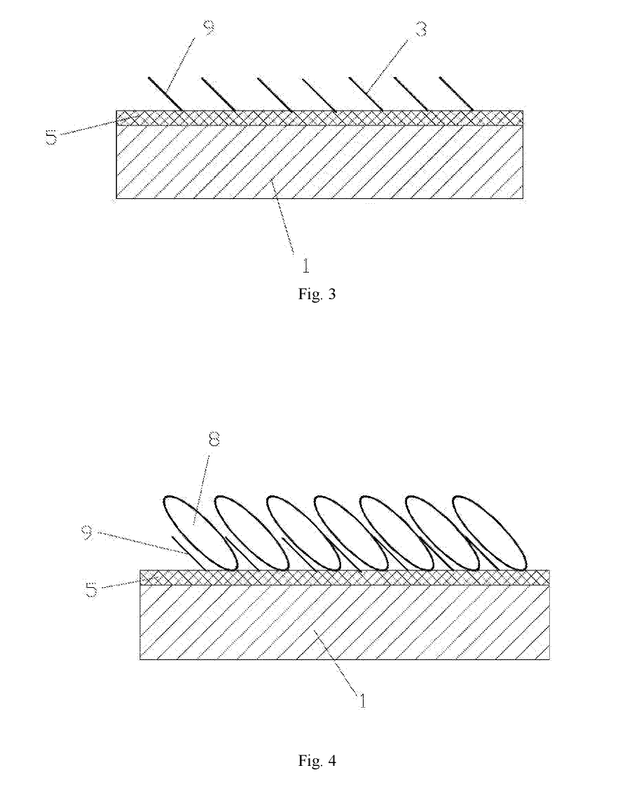

After N-methylpyrrolidone in the liquid state alignment film material completely volatilizes, polyimide forms an alignment film 5 attached on the substrate 1. In this case, the paramagnetic chain-like particles 3 extend outside the alignment film 5 in form of combs 9. As shown in FIG. 3, because the paramagnetic chain-like particles 3 have already been aligned in the direction of the uniform magnetic field 4, the combs 9 extend roughly in parallel. That is, the extending direction of the combs 9 is the abovementioned direction of the uniform magnetic field 4.

Preferably, after the magnetic field 4 is removed, intensified baking is further performed on the substrate 1 at a temperature higher than the pre-baking. In a specific example, the temperature of the intensified baking is in a range from 230 to 250° C. The intensified baking can not only accelerate the volatilization of N-methylpyrrolidone, but also facilitate the polymerization of polyimide, whereby the alignment film 5 can be formed on the substrate 1 firmly. More importantly, intensified baking can destroy the paramagnetism of the paramagnetic chain-like particles 3, whereby the paramagnetic chain-like particles 3 can be prevented from being influenced from other magnetic field and being realigned, which would greatly influence the predetermined liquid crystal alignment, such as the orientation of molecules 8 of the liquid crystal material under the guidance of the combs 9.

At last, liquid crystal material is added into a display region of the substrate 1. Molecules 8 of the liquid crystal material can align in a predetermined direction under the guidance of the combs 9.

In this case, non-contact liquid crystal alignment procedure is realized.

Although the present disclosure has been described with reference to preferred embodiments, as long as there is no structural conflict, various embodiments as well as the respective technical features mentioned herein may be combined with one another in any manner. The present disclosure is not limited to the specific examples disclosed herein, but rather includes all the technical solutions falling within the scope of the claims.

1. A method for liquid crystal alignment, comprising:
step 1: coating liquid state alignment film material containing paramagnetic chain-like particles on a display region of a substrate,
step 2: placing the substrate in a constant magnetic field, so that the paramagnetic chain-like particles are stably aligned in a direction of the magnetic field,
step 3: removing the magnetic field, and
step 4: adding liquid crystal material into the display region of the substrate, so that molecules of the liquid crystal material align in the orientation of the paramagnetic chain-like particles.

2. The method according to claim 1, wherein in step 2, the liquid state alignment film material is further precured.

3. The method according to claim 2, wherein in step 2, the constant magnetic field is a uniform magnetic field.

4. The method according to claim 3, wherein the paramagnetic chain-like particles are copper complex containing [Cu(NH₃)₄]²⁺ or [Cu(H₂O)₄]²⁺.

5. The method according to claim 4, wherein in step 2, the substrate is pre-baked, so that the liquid state alignment film material is precured.

6. The method according to claim 5, wherein the liquid state alignment film material further comprises polyimide and N-methylpyrrolidone as carrier liquid for the paramagnetic chain-like particles.

7. The method according to claim 6, wherein a temperature of a pre-baking procedure is in a range from 80 to 100° C., and a magnetic strength of the uniform magnetic field is in a range from 0.1 to 1.5 T.

8. The method according to claim 6, wherein a mass content of the paramagnetic chain-like particles in the carrier liquid is in a range from 0.2 to 1%.

9. The method according to claim 5, wherein an additional step of removing paramagnetism of the paramagnetic chain-like particles is further performed between step 3 and step 4.

10. The method according to claim 7, wherein an additional step of removing paramagnetism of the paramagnetic chain-like particles is further performed between step 3 and step 4.

11. The method according to claim 8, wherein an additional step of removing paramagnetism of the paramagnetic chain-like particles is further performed between step 3 and step 4.

12. The method according to claim 9, wherein in the additional step, intensified baking is performed on the substrate at a higher temperature than the pre-baking, which is preferably in a range from 230 to 250° C.
